(19) United States
(12) Patent Application Publication
(10) Pub. No.: US 2005/0123880 A1
(43) Pub. Date: Jun. 9, 2005

(54) Method and color kit for color correction of replacement teeth or natural teeth

(76) Inventors: Andreas Grundler, Wuppertal (DE); Alfred Hohmann, Schmitten (DE); Albert Erdrich, Bad Nauheim (DE)

Correspondence Address: Norris, McLaughlin & Marcus P.A., 18th Floor, 875 Third Avenue, New York, NY, 10022, US

(21) Appl. No.: 10/957,057

(22) Filed: Oct. 1, 2004

(30) Foreign Application Priority Data
Oct. 2, 2003 (DE) 103 46 465.4

(51) Int. Cl. A61C 5/00; A61C 13/08

(52) U.S. Cl. 433/215; 433/203.1

(57) ABSTRACT

A method for color correction of replacement teeth or tooth surfaces by application of light-hardening corrective colors for the basic tooth colors is carried out with a color kit comprising: 1 corrective color for the Vita shades A, 1 corrective color for the Vita shades B, 1 corrective color for the Vita shades C, 1 corrective color for the Vita shades D, 1 orange corrective color for individualizing the Vita shades in the red/yellow color range, 1 blue corrective color for individualizing the Vita shades in the blue/green color range, 1 white corrective color for individualizing the Vita shades with respect to brightness and transparency, 1 transparent thinning enamel for adjusting the color intensity and optionally 1 black corrective color to individualize the Vita shades with respect to brightness 1 shade guide with mixing instructions and explanations of correction options, necessary tools like mixing plate, measuring pipette and brush.

The invention relates to a method and a color kit for color correction of all types of tooth replacements (e.g. veneers, crowns, bridges, prosthetic teeth, fillings, inlays, etc.) that may be produced out of all kinds of materials commonly used in the area of dentistry (e.g. composites, ceramic, plastic) and of natural teeth.

There are a number of color systems and color keys that make it easier for the dental technician to adapt the tooth replacement he has produced to the natural indicated tooth color of the patient. Among these is the best known system by far, the so-called Vita® Lumin-Shade Guide containing 16 colors. In this system, the color groups A (red-brown: colors A1, A2, A3, A3.5, A4), B (red-yellow: colors B1, B2, B3, B4), C (gray: colors C1, C2, C3, C4) and D (reddish gray: colors D2, D3, D4) are represented in various intensities.

After visual determination of the brightness and color intensity, the color shade is also selected visually and the dental laboratory is requested to produce the replacement tooth. Vita divides the color shades into four groups, A, B, C and D, which in turn are divided into different intensities.

However it is always possible that after completion of the tooth replacement the color still does not match completely and there is a need for correction.

Methods and systems for correction of such errors are already known for ceramic elements: DE 195 04 31 A1 recommends slightly etching the ceramic and covering it with a thin fluid, hardenable tooth color. DE 31 25 924 A1 relates to the color correction of ceramics without pretreatment of the surface, using preferably nail polish and subsequent blazing. DE 43 40 352 A1 describes the application of a veneer layer. DE 101 26 968 A1 relates to a color kit for producing and coloring the gum portion of dental prostheses.

According to the invention, in the present case a method is suggested for color correction of tooth replacements or natural teeth that makes possible color correction starting from the usual basic colors. To do this, in a preferred embodiment, corrective colors are provided for the Vita basic colors A, B, C and D. These can then be used by dilution of the intensity to create intermediate tones. Preferably, there are three corrective enamels for the color directions orange, white or blue. In this way the color shadings of the human dentition are covered continuously. The enamels can also be adjusted continuously in intensity by using transparent dilution. This is effectively achieved using a transparent enamel. Example embodiments can be found in the color kits described further below.

Naturally, it is possible to use the method for other color systems than the Vita system used as an example. To do this, the color correction tones or the number of corrective colors may be changed if necessary.

The method is suitable for all types of tooth replacements like crowns or artificial teeth, but also of natural teeth or tooth surfaces. Enameling in the direction of bright white can replace e.g. bleaching of the teeth. Before application of the corrective color, the surface of the tooth to be corrected is effectively prepared in the usual way, e.g. by slight etching, grinding and/or application of bonding agents.

Suitable enamels should fulfill the following requirements. This should involve a coating material that hardens with light, that flows, has a pasty or enamel-like consistency, can be applied with a brush, forms a smooth and glossy surface after hardening and finally, results in a coating on a tooth surface or a replacement tooth surface that is resistant to abrasion and gives the proper color impression to the observer.

Preferably the following materials are contained
(A) 40-60 weight-% matrix monomer(s)
(B) 60-40 weight-% filler mixture of quartz
(C) 0.1-1 weight-% (photo) initiator
(D) small quantities of dental pigments.

The matrix monomers are preferably the usual dental monomers, e.g. a mixture of bisphenol-A-diglycidilacrylate, urethane dimethacrylate and triethylene glycol dimethacrylate.

The filler mixture of quartz can preferably be a mixture of quartz and polymer fragments containing quartz. The polymer fragments can be e.g. quartz/polydodecane-diol dimethacrylate. The quartz filler mixture can contain glass fillers (e.g. Ba-Al silicate glass, also containing fluoride) and/or metal oxides and non-metal oxides and their mixed oxides.

The photoinitiator is preferably campher quinone or bisacyl or trisacyl phosphinoxide.

The pigments are preferably pigments used in the dental industry, e.g. iron oxide, chromium-iron-zinc spinel, titanium dioxide, copper-chromium-iron spinel, cobalt-aluminum spinel and zircon oxide.

Further embodiments of the invention are so-called color kits, i.e. combinations of individual components with which the method according to the invention can be carried out. Preferably the suitable shade guides, instructions and tools are included. In particular, it is possible to offer corrective colors for Vita shades A, B, C, D separately and corrective colors in the direction of blue, yellow or white separately, in each case preferably with transparent enamel and black enamel.

The invention thus also relates to a color kit for color correction of tooth replacements or tooth surfaces, comprising the following components:
1 corrective color for the Vita basic tooth colors A,
1 corrective color for the Vita basic tooth colors B,
1 corrective color for the Vita basic tooth colors C,
1 corrective color for the Vita basic tooth colors D,
1 transparent thinning enamel for adjusting the color intensity and optionally
1 black corrective color to individualize the Vita basic tooth colors with respect to brightness, in addition a
color kit for color correction of tooth replacements or tooth surfaces, comprising the following components:
1 orange corrective color for individualizing the Vita basic tooth colors in the red/yellow color range,
1 blue corrective color for individualizing the Vita basic tooth colors in the blue/green color range,
1 white corrective color for individualizing the Vita basic tooth colors with respect to brightness and transparency,
1 transparent thinning enamel for adjusting the color intensity and optionally
1 black corrective color to individualize the Vita basic tooth colors with respect to brightness, and additionally
a combined color kit for color correction of tooth replacements or tooth surfaces, comprising the following components:
1 corrective color for the Vita basic tooth colors A,
1 corrective color for the Vita basic tooth colors B,
1 corrective color for the Vita basic tooth colors C,
1 corrective color for the Vita basic tooth colors D,
1 orange corrective color for individualizing the Vita basic tooth colors in the red/yellow color range,
1 blue corrective color for individualizing the Vita basic tooth colors in the blue/green color range,
1 white corrective color for individualizing the Vita basic tooth colors with respect to brightness and transparency,
1 transparent thinning enamel for adjusting the color intensity and optionally
1 black corrective color to individualize the Vita basic tooth colors with respect to brightness.

In addition to this, for each shade guide there can be mixing instructions and explanations of the correction options, as well as suitable tools like mixing plate, measuring pipette and brush.

In practice, the method according to the invention for color correction can be used e.g. in the following manner described for color adaptation of composite faced crowns:
The surface of the polymerized faced crown is roughened using a blast cleaner with Al₂O₃ sand and a pressure of 2 bar.
The surface is cleaned using a water/air spray and then dried.
An activation fluid like c&b liquid (Heraeus Kulzer Co.) is applied with a brush (composition: dimethacrylate, multi-functional methacrylic acid ester, bonding hydrosilicon, photoinitiators).
Depending on the color correction to be made, the necessary colors are selected from the kit of color enamels according to the invention, mixed if necessary and applied with a brush according to the desired color effect.
The color enamel according to the invention is polymerized with a polymerizing device (e.g. Heraflash, Heraeus Kulzer Co.).
The surface of the color-corrected faced crown is polished if necessary with suitable polishing systems to obtain a high gloss (e.g. Prepol and Hipol, Heraeus Kulzer Co.).

This basic method is adapted depending on the application (e.g. surface materials, intraoral or extraoral use) with respect to the surface treatment of the surface whose color is to be corrected, the bonding of the corrective enamels and the device used for hardening.

For color individualization and correction of a natural tooth, the bonding is carried out, e.g. using the usual method like etching and bonding.

For the correction of PMMA prosthetic teeth, other activations solutions are suitable (e.g. c&b connector, Heraeus Kulzer Co., a light-hardening conditioner for bonding light-hardening c&b facing materials to PMMA hot and cold polymerides and plastic prosthetic teeth). Composition: methylmetacrylate, polymethylmetacrylate, urethane dimethacrylate, photoinitiators.

The usual silanization methods, for example, are available for correction of ceramic surfaces.

1. Method for color correction of replacement teeth or tooth surfaces comprising application of light-hardening corrective colors for basic tooth colors.

2. Method according to claim 1, comprising application of at least one of four light-hardening corrective colors in the directions orange, blue, black and white.

3. Method according to claim 1, comprising application of at least one of four light-hardening corrective colors for the basic tooth colors Vita A, B, C and D.

4. Color kit for color correction of replacement teeth or tooth surfaces, comprising the following components:
1 corrective color for the Vita basic tooth colors A,
1 corrective color for the Vita basic tooth colors B,
1 corrective color for the Vita basic tooth colors C,
1 corrective color for the Vita basic tooth colors D,
1 transparent thinning enamel for adjusting the color intensity and optionally
1 black corrective color to individualize the Vita basic tooth colors with respect to brightness.

5. Color kit according to claim 4, comprising the following components:
1 orange corrective color for individualizing the Vita basic tooth colors in a red/yellow color range,
1 blue corrective color for individualizing the Vita basic tooth colors in a blue/green color range,
1 white corrective color for individualizing the Vita basic tooth colors with respect to brightness and transparency,
1 transparent thinning enamel for adjusting the color intensity and optionally
1 black corrective color to individualize the Vita basic tooth colors with respect to brightness.

6. Color kit according to claim 4, comprising the following components:
1 corrective color for the Vita basic tooth colors A,
1 corrective color for the Vita basic tooth colors B,
1 corrective color for the Vita basic tooth colors C,
1 corrective color for the Vita basic tooth colors D,
1 orange corrective color for individualizing the Vita basic tooth colors in the red/yellow color range,
1 blue corrective color for individualizing the Vita basic tooth colors in the blue/green color range,
1 white corrective color for individualizing the Vita basic tooth colors with respect to brightness and transparency,
1 transparent thinning enamel for adjusting the color intensity and optionally
1 black corrective color to individualize the Vita basic tooth colors with respect to brightness.

7. Method according to claim 1, wherein the corrective colors and the thinner enamel comprise:
(A) 40-60 weight-% matrix monomer(s),
(B) 60-40 weight-% filler mixture of quartz and/or polyester fragments containing quartz and/or metal oxides and/or non-metal oxides and their mixed oxides and/or dental glass,
(C) 0.1-1 weight-% (photo) initiator and
(D) optionally dental pigments.

8. Color kit according to claim 4, wherein the corrective colors and the thinner enamel comprise:
(A) 40-60 weight-% matrix monomer(s),
(B) 60-40 weight-% filler mixture of quartz and/or polyester fragments containing quartz and/or metal oxides and/or non-metal oxides and their mixed oxides and/or dental glass,
(C) 0.1-1 weight-% (photo) initiator and
(D) optionally dental pigments.
